(19) United States
(12) Patent Application Publication
(10) Pub. No.: US 2016/0048035 A1
(43) Pub. Date: Feb. 18, 2016

(54) Eyeglass Lens Saver Clips

(71) Applicant: Michael Phillip Carter, Flatwoods, KY (US)

(72) Inventor: Michael Phillip Carter, Flatwoods, KY (US)

(21) Appl. No.: 14/307,449

(22) Filed: Aug. 14, 2014

(51) Int. Cl. G02C 3/04; G02C 11/00

(52) U.S. Cl. CPC G02C 3/04; G02C 11/00

(57) ABSTRACT

The clip is designed to secure eyewear to an article upon a person or nearby place to be readily available. The clip will help prevent damage, broken, lost or stolen eyewear. The clip can be soldered, screwed, molded by plastic extrusion, glued or clamped onto the temple of the eyewear or by any other available means.

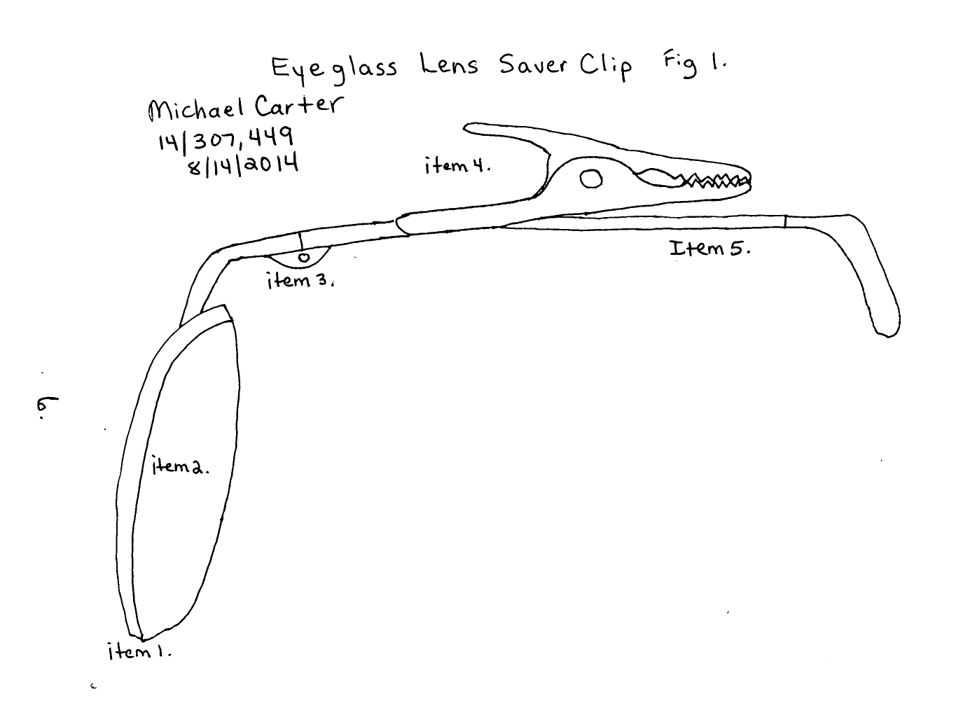

1. When working in my shop area, my glasses continuously fell out of my shirt pocket. I attached an alligator clip to the temple of the glasses and attached them to my shirt pocket. This ended my problem of them falling out and were readily available when needed. The invention is designed to prevent scratching, damaging, miss placing, or stolen eye wear by allowing a person to attach the frames securely to any article on their person.

2. The drawing depicts an alligator clip which can be incorporated onto the temple of any pair of glasses. But any type of material such as plastic, metals, alloys or wooden material can be used to design and incorporate this clip for pleasing aesthetic.

3. In the drawing, which is a part of the specification:
Drawing 1. item 1 is the frame of a pair of glasses
   Item 2 is the lens
   Item 3 is hinge
   Item 4 is the alligator clip attached to the temple
   Item 5 is the temple

1. An apparatus attached to eyewear to securely fasten to any article of clothing or accessory to prevent damage, miss placing or theft.
